(19) United States
(12) Patent Application Publication
(10) Pub. No.: US 2009/0199712 A1
(43) Pub. Date: Aug. 13, 2009

(54) Method and Device for the Absorption of Acid Gas From Natural Gas

(76) Inventors: Johannes Menzel, Waltrop (DE); Martin Cosfeld, Bochum (DE)

Correspondence Address: MARSHALL & MELHORN, LLC, FOUR SEAGATE - EIGHTH FLOOR, TOLEDO, OH, 43604, US

(21) Appl. No.: 11/922,170

(22) PCT Filed: May 23, 2006
(86) PCT No.: PCT/EP2006/004872

§ 371 Date: Dec. 13, 2007

(30) Foreign Application Priority Data
Jun. 27, 2005 (DE) 10 2005 030 028.6

(51) Int. Cl. B01D 53/14

(52) U.S. Cl. 95/163; 95/179; 95/180; 96/235

(57) ABSTRACT

A method and a device for the absorption of pressurised natural gas containing at least hydrogen sulphide and carbon dioxide, using a physically active absorption agent. The natural gas containing acid gas is first conveyed to an absorption column, where it is directly contacted with the physical detergent, and the physical detergent absorbs the acid gas, leaving only a residue. The charged detergent is conveyed to a stripping column, the working pressure being further reduced. The residue of the released acid gas from the detergent is desorbed in said stripping column. The detergent thus regenerated is returned, at least in part, to the absorption column. The acid gas leaving the first separator is conveyed to another absorption column, in which the part of the released acid gas containing predominately hydrogen sulphide is reabsorbed with regenerated detergent and mixed with the charged detergent from the first separator. The remaining acid gas not reabsorbed from the absorption column downstream of the first separator, is recovered as stripping gas. Said stripping gas is used in the stripping column for removing the hydrogen sulphide from the detergent supplied to the stripping column. The finely regenerated solvent is divided into two partial flows, one of which is conveyed to the absorption column downstream of the first separator stage while the other is conveyed to the absorption column in the flow of natural gas.

The invention relates to a process and device for the absorption of sour gas to be removed from crude natural gas, using a physically acting solvent. Appropriate absorption devices are used for crude natural gases, which—in addition to useful components such as methane—contain higher hydrocarbons, hydrogen, carbon dioxide, impurities such as hydrogen sulphide, organic sulphur components such as mercaptan and carbon oxide sulphide, and also—if undesired—carbon dioxide and small amounts of water vapour in different portions.

As a rule, it is necessary to reduce, for example, the sulphur components contained in crude natural gas to a given ppm content in order to permit further technical exploitation. The removal of hydrogen sulphide, mercaptans, carbon dioxide and other sour gas components from natural gas is generally effected with the aid of chemically acting absorbents such as amine solutions, alkali salt solutions, etc., or physically acting absorbents such as Selexol, propylene carbonate, n-methyl-pyrrolidon, Morphysorb, methanol, etc., circulated in a loop system, physically acting absorbents being capable—contrary to chemically acting washing agents—of removing organic sulphur components, too. Depending on the target or task involved, the carbon dioxide contained in the gas is removed completely, in part or in as small quantities as possible.

As physically acting absorbents also co-absorb, as a rule, a certain portion of hydrocarbons during the removal of sour gas components from natural gas, the solution leaving the absorber is normally depressurised in a recycle flash vessel prior to the desorption of the sour gases to a pressure lower than that of the absorption step, the released flash gas being re-compressed by means of a recycle compressor and added to the input gas as recycle gas upstream of the absorption step in order to undergo re-purification.

The intense regeneration of the absorbent required to obtain a removal of the sulphur components in the ppm range is normally effected by a method that uses thermal stripping of the laden absorbent solution in a desorption column, i.e. boiling and evaporating part of the solvent in the bottom of the said column, thus eliminating the sour gas components almost completely. A disadvantage of this process is that a huge energy input is required because the absorption solution must be heated to the boiling point to make it evaporate. In the absorption with the aid of a physically acting absorbent this is particularly disadvantageous because the absorption solution must, as a rule, be fed in a very cold state (0 to −40° C.) to the absorption column in order to ensure favourable absorption conditions for the sour gas absorption. Hence, heating of the absorbent additionally necessitates re-cooling with the aid of expensive cooling energy.

Therefore, the objective of the invention is to provide a process in which almost no thermal energy is required for the intense regeneration of the solvent or at least substantially less thermal energy than that needed for state-of-the-art thermal regeneration, i.e. without making use of external stripping gas or stripping gas available within the battery limits.

The objective of the invention is achieved as follows:
The sour gas contained in the natural gas is first piped to an absorption column, in which it comes into direct contact with a physically acting washing agent, the latter absorbing the sour gas and leaving a residual content of sour gas only;
the laden washing agent is fed to a first separator, thereby reducing the working pressure and part of the solved sour gas being removed from the washing agent;
at least a part stream of the laden washing agent undergoes a further pressure reduction and treatment in a stripping column where the residual content of solved sour gas is removed from the washing agent;
at least part of the thus regenerated washing agent is returned to the absorption column;
the sour gas leaving the first separator is fed to a further absorption column in which regenerated washing agent is used to re-absorb a released sour gas portion that mainly contains hydrogen sulphide and that is added to the laden washing agent in the first separator;
the remaining sour gas portion not re-absorbed in the absorption column downstream of the first separator is recovered as stripping gas;
the said stripping gas is utilised in the stripping column for removing the hydrogen sulphide from the washing agent fed to the stripping column, and
the intensely regenerated solvent being split up into two part streams, the first one being piped to the absorption column downstream of the first separator step and the second one being fed to the absorption column arranged in the natural gas stream.

In an embodiment of the process in accordance with the invention, the washing agent leaving the first separator undergoes a working pressure reduction and is piped to a second separator prior to feeding the partly laden washing agent to the stripping column.

An advantageous rating of the individual pressure steps is selected such
that the pressure of the sour gas absorption is >50 bar, preferably 70 bar,
that the pressure in the first separator is in the range of 6 to 30 bar, preferably 15 bar, and
that the pressure in the stripping column is in the range of 0.2 to 3 bar.
   If a second separator is provided, the pressure of the said separator should be rated between 1 and 3 bar, preferably 1 bar, but in any case above the stripping column pressure.

In a further embodiment of the process in accordance with the invention, provision is made for the criterion that the used physically acting solvent also co-absorbs useful hydrocarbon compounds which should not be separated. Therefore, a recycle gas flash step is arranged upstream of the first separator in order to ensure a pressure reduction of the laden solvent to a value between the absorption pressure and that of the first separator, the released and co-absorbed flash gas, which also contains useful gas components, being returned to the upstream side of the absorption column by means of a recycle compressor.

According to further embodiments of the process described in accordance with the present invention, the laden solvent is pre-heated with the aid of a pre-heater prior to entering the stripping column, and the warm regenerated solvent leaving the said column is cooled by way of heat exchange with the laden solvent piped to the pre-heater and subsequently undergoes a secondary cooling prior to using the secondary-cooled and regenerated solution for the absorption.

In a further embodiment of the process in accordance with the invention, the solvent used is a mixture of n-formylmorpholine and n-acetylmorpholine.

The invention also encompasses adequate devices required to perform the said process. The process configuration provides for a constructional unit formed by the first separator and the absorption column arranged downstream on the sour gas side, the first separator being integrated into the bottom of the absorption column. Furthermore, the said configuration also consists of a constructional unit formed by the second separator and the stripping column, the second separator being stacked on top of the stripping column head and equipped with liquid drain piping that includes a device for pressure reduction, a header for liquid fluids in the stripping column head zone, an inlet for laden washing agent in the stripping column bottom as well as withdrawing devices for sour gas in the head zone of the stripping column and in the second separator.

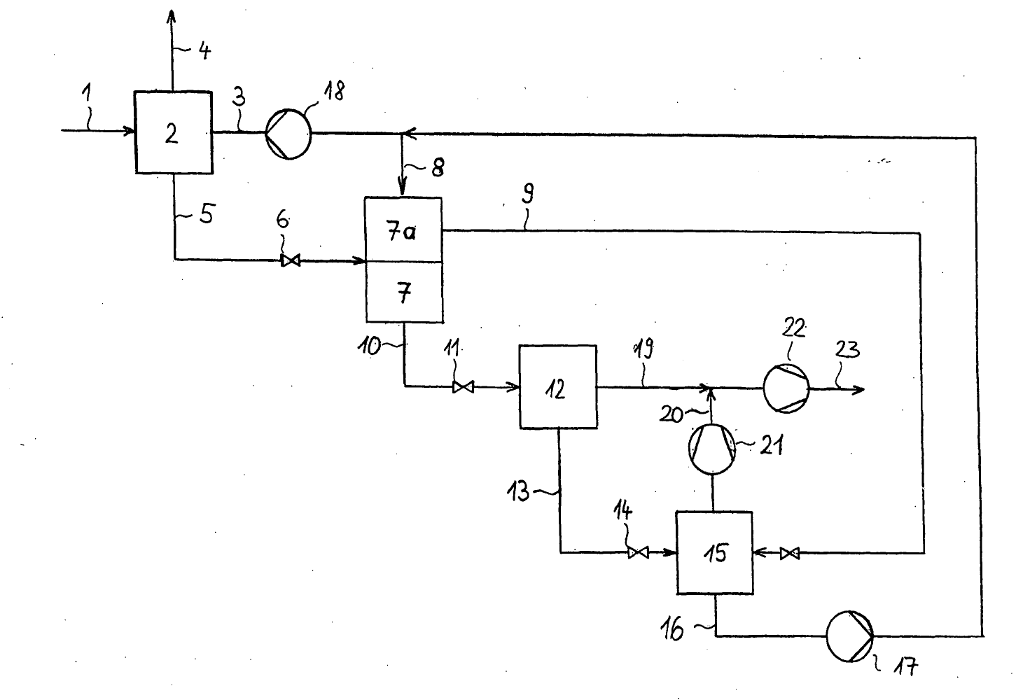

The invention is detailed below on the basis of a flow sheet shown in FIG. 1 which depicts the process according to the present invention and illustrates the process equipment: absorption column 2, first separator 7 with stacked absorption column 7a, second separator 12 and stripping column 15 as well as the major process streams.

Crude natural gas 1 is piped to absorption column 2 in which it is washed with solvent 3 at a pressure of 91 bar and which it leaves as purified natural gas 4. Laden solvent 5 is depressurised to 13 bar in flash device 6 and is then directly sent to the bottom of first separator 7 with stacked absorption column 7a. A given part of the sour gas is released from the laden solvent and flows into stacked column 7a in which a certain portion thereof is re-absorbed by fresh solvent 8. Thus, stripping gas 9 with a low H₂S content is obtained. In the bottom the added solvent mixes with laden solvent 5 originating from absorption column 2.

Withdrawn laden solvent 10 is further depressurised to 1.1 bar in flash device 11 and piped to second separator 12 in which the major part of the sour gas is removed from the solvent. Solvent 13 still bearing residual sour gas is further depressurised to 0.6 bar in flash device 14 and piped to stripping column 15 in which the residual sour gas is removed from the solvent with the aid of stripping gas 9 with low H₂S content.

Solvent 16 thus regenerated is pumped by solvent pump 17 to first separator 7 with stacked absorption column 7a and via the branch line to absorption column 2 and finally, it undergoes a further increase in pressure by solvent pump 18 and is fed to the head of absorption column 2.

Sour gas 19 withdrawn from second separator 12 is mixed with sour gas stream 20 withdrawn from stripping column 15 by vacuum pump 21 and then sent by conveying compressor 22 to sour gas exploitation unit 23.

The calculation example given in Table 1 further illustrates the process fundamentals, the stream numbers used referring to the process shown in FIG. 1. The data indicated refer to 1000 kg natural gas per hour, to the process principle, however, it is irrelevant whether the flow rate of crude natural gas to be purified by this process is actually 10 tonnes/h or 500 tonnes/h.

TABLE 1

| Stream number | 1 | 4 | 19 | 20 | 23 | 9 |
|---|---|---|---|---|---|---|
| kmol/h | 42.3 | 32.9 | 5.1 | 4.2 | 9.3 | 2.1 |
| kg/h | 1000 | 673.6 | 192.9 | 133.6 | 326.5 | 53.7 |
| m³/h | 9.2 | 7.4 | 113.3 | 114.4 | 26.1 | 4.0 |
| Temperature [° C.] | 50.0 | 37.6 | 23.8 | 70.2 | 50.0 | 19.9 |
| Pressure [bar_{abs}] | 92.0 | 90.5 | 1.1 | 1.1 | 9.0 | 12.0 |
| Density [kg/m³] | 108.5 | 91.1 | 1.7 | 1.2 | 12.5 | 13.4 |
| N₂ [molar %] | 1.3699 | 1.7389 | 0.0022 | 0.1432 | 0.0662 | 0.2916 |
| CO₂ [molar %] | 4.8397 | 3.8316 | 8.9619 | 7.7233 | 8.4001 | 15.7369 |
| H₂S [molar %] | 13.9090 | 0.0071 | 75.6331 | 47.8106 | 63.0136 | 0.0740 |
| CH₄ [molar %] | 65.8754 | 80.4083 | 2.2635 | 29.3205 | 14.5357 | 59.8363 |
| C₂H₆ [molar %] | 7.6895 | 8.6662 | 2.1551 | 6.7480 | 4.2383 | 13.9583 |
| C₃H₈ [molar %] | 3.3098 | 3.4062 | 2.6074 | 3.4041 | 2.9688 | 7.0541 |
| n-butane [molar %] | 1.5099 | 1.1629 | 3.7015 | 1.5715 | 2.7354 | 2.2558 |
| n-pentane [molar %] | 0.6200 | 0.5389 | 1.2208 | 0.5274 | 0.9063 | 0.7855 |
| n-hexane [molar %] | 0.8599 | 0.2360 | 3.3882 | 2.6732 | 3.0639 | 0.0033 |
| Methylmercaptan | 0.0050 | 0.0003 | 0.0193 | 0.0241 | 0.0215 | 0.0008 |
| [molar %] | | | | | | |
| Ethylmercaptan [molar %] | 0.0040 | 0.0006 | 0.0143 | 0.0178 | 0.0159 | 0.0010 |

### KEY TO REFERENCED ITEMS

1 Crude natural gas
2 Absorption column
3 Regenerated solvent
4 Purified natural gas
5 Laden solvent
6 Flash device
7 First separator
7a Stacked absorption column
8 Regenerated solvent
9 Stripping gas with low H₂S content
10 Laden solvent
11 Flash device
12 Second separator
13 Laden solvent
14 Flash device
15 Stripping column
16 Regenerated solvent
17 Solvent pump
18 Solvent pump
19 Sour gas
20 Sour gas
21 Vacuum pump
22 Conveying compressor
23 Sour gas exploitation unit

1-10. (canceled)

11. A process for the absorption of pressurized natural gas containing at least hydrogen sulphide and carbon dioxide, with the aid of physically acting absorbents, comprising
piping sour gas-bearing natural gas to an absorption column in which it comes into direct contact with a physically acting washing agent, the latter absorbing the sour gas and leaving a residual sour gas content only,
feeding laden washing agent to a first separator, thereby reducing the working pressure and part of the solved sour gas being removed from the washing agent,
at least a part stream of laden washing agent again undergoing a working pressure reduction and treatment in a stripping column where the residual content of solved sour gas is removed from the washing agent,
returning at least part of thus regenerated washing agent to the absorption column,
feeding sour gas leaving the first separator to a further absorption column in which regenerated washing agent is used to re-absorb a released sour gas portion that mainly contains hydrogen sulphide and that is added to laden washing agent in the first separator,
the remaining sour gas portion not re-absorbed in the further absorption column arranged downstream of the first separator is recovered as stripping gas,
said stripping gas is utilized in a stripping column for removing the hydrogen sulphide from the washing agent fed to the stripping column, and
the intensely regenerated solvent is split up into two part streams, the first one being piped to the further absorption column arranged downstream of the first separator and the second one being fed to the absorption column arranged in the natural gas stream.

12. The process according to claim 11, wherein the washing agent leaving the first separator undergoes a working pressure reduction and is piped to the second separator prior to feeding the partly laden washing agent to the stripping column.

13. The process according to claim 11, wherein
the pressure selected for the sour gas absorption is >50 bar,
the pressure in the first separator is in the range of 6 to 30 bar, and
the pressure selected for the stripping column is in the range of 0.2 to 3 bar.

14. The process according to claim 12, wherein the pressure in the second separator is rated in the range of 1 to 3 bar, but in any case above the pressure in the stripping column.

15. The process according to claim 11, wherein a recycle gas flash step is arranged upstream of the first separator in order to ensure a pressure reduction of the laden solvent to a value between the absorption pressure and that of the first separator, the released and co-absorbed flash gas, which also contains useful gas components, is being returned to the upstream side of the absorption column by means of a recycle compressor.

16. The process according to claim 11, wherein the laden solvent is pre-heated with the aid of a pre-heater prior to entering the stripping column.

17. The process according to claim 16, wherein the warm regenerated solvent leaving the stripping column is cooled by way of heat exchange with the laden solvent piped to the pre-heater and subsequently undergoes a secondary cooling prior to using the secondary-cooled and regenerated solution for absorption.

18. The process according to claim 11, wherein the solvent is a mixture of n-formylmorpholine and n-acetylmorpholine.

19. A device suited for the process described in claim 11, wherein the first separator and the further absorption column arranged downstream on the sour gas side form a constructional unit, the first separator being integrated into the bottom of the absorption column.

20. A device suited for the process described in claim 12, wherein the second separator and the stripping column form a constructional unit, the separator being stacked on top of the head of the stripping column and equipped with a liquid drain piping that includes a device for pressure reduction, a header for liquid fluids in the stripping column head zone, an inlet for laden washing agent in the stripping column bottom as well as withdrawing devices for sour gas in the head zone of the stripping column and in the second separator.

21. The process according to claim 13, wherein
the pressure selected for the sour gas absorption is about 70 bar, and
the pressure in first separator is about 15 bar.

22. The process according to claim 14, wherein the pressure in second separator is about 1 bar.
